(19) United States
(12) Patent Application Publication
(10) Pub. No.: US 2008/0089336 A1
(43) Pub. Date: Apr. 17, 2008

(54) LOCATION OF A PROBE ALGORITHM

(76) Inventors: Christina Woody Mercier, Sunnyvale, CA (US); Barry Hughes Feild, Scotts Valley, CA (US)

Correspondence Address: ERIC L. MASCHOFF;Workmanman Nydegger, 1000 Eagle Gate Tower, 60 E. South Temple, Salt Lake City, UT, 84111, US

(21) Appl. No.: 11/550,384

(22) Filed: Oct. 17, 2006

(51) Int. Cl. H04L 12/56

(52) U.S. Cl. 370/392; 370/401

(57) ABSTRACT

Methods and systems for determining a location of a probe in a network are disclosed. Several methods analyze network data received by a probe to identify at least two devices in the network between which the network data is transferred. The method further includes assigning a level of certainty as to the location of the probe based on the at least two devices of the network identified. Another method for gathering information describing a location of a probe includes receiving network data from a probe, the network data representing data transmitted in the SAN through a link coupled to the probe. The link in the SAN from which the information is received defines a location of the probe. The method further includes analyzing at least a portion of a header within the network data to gather information describing the location of the probe. The location of the probe can be included in a topology of the network and the topology can be displayed along with a visual representation of the location of the probe.

### BACKGROUND

Storage Area Networks (SANs) have become an increasingly important part of the enterprise information technology infrastructure and a building block of mission critical business applications. A SAN is a network designed to attach computer storage devices such as disk array controllers and tape libraries to servers. Enterprise storage is the field of information technology focused on the storage, protection, and retrieval of data in large-scale environments.

Many different types of SAN protocols and infrastructures exist. For example, one common SAN technology is Fibre-Channel (FC) networking with the SCSI command set. A typical FC SAN is made up of a number of FC switches which are connected together to form a fabric. A more recently employed SAN protocol is iSCSI which uses the same SCSI command set over TCP/IP (and, typically, Ethernet). In this case, the switches are Ethernet switches. Another often used protocol is the ATA-over-Ethernet or AoE protocol which embeds the ATA protocol inside of raw Ethernet frames. Connected to the SAN are one or more servers (hosts) and one or more disk arrays, tape libraries, or other storage devices. In the case of a FC SAN, for example, the servers use special FC Host Bus Adapters (HBAs) and optical fiber. iSCSI SANs, on the other hand, normally use Ethernet network interface cards, and often specialized TCP/IP Offload Engine (TOE) cards.

In many instances it is beneficial to monitor SAN performance. One problem with SANs can be that the switches and other hardware from different manufacturers are not entirely compatible. Although the basic storage protocols (such as FCP) have been standardized, some of the higher-level functions may not interoperate well. It is often advantageous to monitor SANS for such interoperability between the various components. In addition, applications can be monitored for performance degradation and potential downtime due to SAN failures.

It may also be desirable to monitor conditions that may affect SAN traffic or resource availability such as network utilization, bandwidth, CRC errors, SCSI check conditions and aborts, etc. For example, delays within a fabric or WAN (between multiple fabrics) may impact the operation of the entire SAN. In response to these problems and others, different devices have been developed to monitor, diagnose and prevent SAN performance slowdowns and failures, data corruption, and other errors in SANs. Dedicated hardware and/or software monitoring solutions have enabled SAN administrators to view critical data about their SAN and increase performance and reliability.

A device called a portal has been developed that gathers network data from probes coupled to the SAN and stores the network data for viewing and traffic analysis. The network data contains information about data transferred in a SAN as well as various error conditions, etc. The portal collects network data and summarizes it over time according to user-defined schedules. The portal also allows alarms to be set that specify actions to be carried out when pre-defined thresholds are breached.

Probes are most commonly connected to the SAN through a network tap. Network taps can be dedicated or roving across multiple SAN links. Hardware probes, for example, gather all of the transactions at the Initiator/Target/LUN level (host to storage conversations), providing detailed statistics describing the SAN's performance. If hardware cannot be inserted in the fabric, a software probe may provide an alternative approach that allows a subset of statistics to be gathered directly from FC switches through SNMP, for example. Probes deliver accurate, real-time FC and SCSI statistics to a portal or other data processing device.

Typically, a location of a link in a fabric from which a probe receives network data (hereinafter referred to as “location of a probe”) must be physically known and selected by an operator in order to understand how the particular nodes and links of the fabric are affected by various conditions in the SAN. As enterprise applications become of increased importance and physical locality of operators becomes less commonplace, it becomes increasingly difficult for an operator to identify and keep track of the location of each probe. For example, an operator performing analysis of a SAN may be in a different country from the physical location of the SAN. The operator may also have limited access to topologies and schematics describing the SAN layout or locations of various probes inserted into the SAN at different times. Moreover, as SAN infrastructure becomes increasingly complex, it becomes more difficult to track the location of each probe. Thus, what would be advantageous are methods for gathering information describing the location of a probe in a network, such as a SAN.

### BRIEF SUMMARY OF SEVERAL EXAMPLE EMBODIMENTS

A method for gathering information describing a location of a probe in a network is disclosed. The method includes analyzing network data received by the probe to identify the two entities (device node ports, SAN services, etc.) in the network between which the network data is transferred. The method further includes assigning a level of certainty as to the location of the probe based on how the devices and/or services were identified.

A method for gathering information describing a location of a probe in a network is disclosed. The method includes receiving network data from a probe, the network data representing data transmitted in the SAN through a link coupled to the probe, the link in the SAN from which the information is received defining a location of the probe. The method further includes analyzing at least a portion of a header within the network data to gather information describing the location of the probe.

A method for gathering information describing a location of a probe in a network is disclosed. The method includes first searching network data received from the probe for at least one of the following: a fabric login, a node port to service transmission, or a transmission between two switches. If the fabric login, node port to service transmission, or transmission between two switches is found, the method further includes identifying the location of the probe based on the fabric login, node port to service transmission, or transmission between two switches.

If the fabric login, node port service, or transmission between two switches is not found, the method can further include searching all of the network data received from that probe for at least one of the following conditions: the headers on channel A (i.e., transmit or receive) include identical N_Port source address identifiers (SIDs) and the headers on channel B (receive or transmit) include identical N_Port destination address identifiers (DIDs) that are the same as the SIDs on channel A and at least two unique N_Port DIDs are found on channel A or at least two unique N_Port SIDs are found on channel B, the headers on channel A (i.e., transmit or receive) include identical N_Port DIDs and the headers on channel B (receive or transmit) include identical N_Port SIDs that are the same as the DIDs on channel A and at least two unique N_Port SIDs are found on channel A or at least two unique N_Port DIDs are found on channel B, the headers include at least two unique source addresses and at least two unique destination addresses on the channel pairs, a start of frame field that is a start of frame fabric (SOFf) delimiter, or the headers include exactly two unique N_Port (i.e., not WKA or Domain Controller addresses) FCIDs in all of the source addresses and destination addresses.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 discloses an example of a FC frame;

FIGS. 2A and 2B disclose examples of networks including probes for gathering network data according to example embodiments;

FIG. 3 discloses a method for gathering information describing a location of a probe;

FIG. 4 discloses a method for gathering information describing a location of a probe;

FIG. 5 discloses a method for gathering information describing a location of a probe; and

FIG. 6 discloses an example of a system for implementing several embodiments.

### DETAILED DESCRIPTION OF SEVERAL EMBODIMENTS

The principles of the embodiments described herein describe the structure and operation of several examples used to illustrate the present invention. It should be understood that the drawings are diagrammatic and schematic representations of such example embodiments and, accordingly, are not limiting of the scope of the present invention, nor are the drawings necessarily drawn to scale. Well known devices and processes have been excluded so as not to obscure the discussion in details that would be known to one of ordinary skill in the art.

Several embodiments described herein relate to gathering information describing a location of a probe based on data transmitted over a link of a network, such as a SAN. This information may be gathered, for example, by identifying network data that is only transferred over certain links or portions of a SAN. Several approaches may produce different levels of certainty as to the location of the probe in the SAN. In some instances, an exact certainty as to the location of the probe may be determined, whereas according to other embodiments a diminished level of certainty may be determined as to the location of the probe. Over time, additional information may be gathered, further increasing the level of certainty as to the location of the probe in the SAN. In some instances, enough information can be gathered over time that an exact certainty is obtained as to the location of the probe.

According to an example embodiment, network data is received from a link of a SAN coupled to a probe. The network data can be received by a network tap transferring the network data from a link of the SAN to the probe. The network data is analyzed to determine a location of the probe in the SAN. For example, where the network data includes fields identifying a source or intended destination of the network data, this information can be analyzed to establish a level of certainty as to the location of the probe.

According to several embodiments discussed herein, frame headers can be analyzed to determine the location of a probe in exact certainty. According to other embodiments discussed herein, a level of certainty may be made as to the location of the probe. For example, by analyzing at least one header, certain locations (e.g. links) in a SAN may be excluded from consideration as the location of the probe. Moreover, an analysis of a header may indicate that the probe is more likely to be located at one location as opposed to another location. Thus, a heuristic approach can be carried out taking into consideration information contained in headers of different frames to establish a level of certainty as to the location of the probe. Different levels of certainty as to the location of a probe (or multiple probes) can be assigned to different links within a network. Moreover, where multiple probes have been placed in a SAN and a placement criteria or topology of the SAN is known, the location of a first probe may also provide information as to the location of another probe(s).

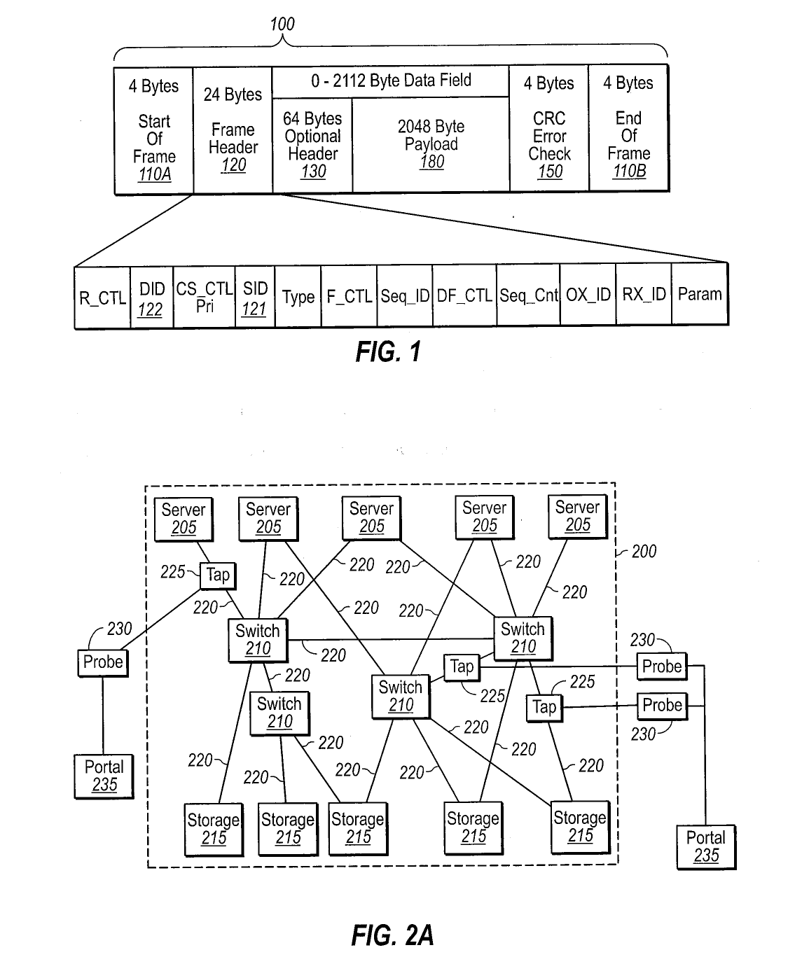

In SANs incorporating FC links, for example, the network data is typically transferred using FC frames. FC frames typically include headers including routing information. For example, referring to FIG. 1, an example of a FC frame 100 is illustrated. The FC frame 100 begins and ends with a frame delimiter 110A and 110B. A frame header 120 immediately follows a start of frame (SOF) delimiter 110A. The frame header 120 can be used to control link applications, control device protocol transfers, and detect missing or out of order frames, for example. An optional header 130 may contain further link control information. A payload 180 contains the information to be transferred. A Cyclic Redundancy Check (CRC) 150 field precedes an end of frame (EOF) delimiter 110B. The CRC 150 can be used to detect transmission errors.

In addition to other information, the header 120 of the FC frame contains information describing the address of a source port (SID) 121 and an address of a destination port (DID) 122. Several embodiments disclosed herein analyze the SID 121 and the DID 122 to gather information describing the location of a probe. In some instances, there may be multiple SIDs 121 and/or DIDs 122 in different frame headers 120. In this instance, the analysis can take into consideration any, or all, of the SIDs 121 and DIDs 122 carried by the frame 100 or by multiple frames.

The SID 121 identifies the source of a frame. The SID 121 is a 3-Byte FCID that is contained within a FC frame that represents a port on the device from which the frame originated. A SID 121 may be a Well Known Address (WKA) or the FCID of the node port (N_Port). An SID of 0x000000 is typically used during fabric login before the node port has obtained its FCID.

The DID 122 identifies the destination of a frame. The DID 122 is a 3-Byte FCID that is contained within a FC frame and represents the destination device of the frame. A DID 122 may be a WKA or the address of an N_Port.

Some identifiers are also referred to by a World Wide Name (WWN). WWNs are unique identifiers that are typically 8 or 16 bytes in length.

Another field that can be analyzed is an Organizational Unique Identifier Field (OUI Field). OUI Fields typically include a 3 byte portion of the WWN that uniquely identifies the vendor of a device. This information may also be used to identify a location of a probe where a manufacturer of a device in the network is known.

An Inter-Switch Link (ISL) is a link used to connect multiple switches into a single fabric. The port on each end of an ISL is typically referred to as an Expansion port (E-port). Virtual SANs that span multiple switches are connected with Trunked E-ports (TE-ports). Identifying network data that is only transferred over an ISL can provide information describing the location of a probe.

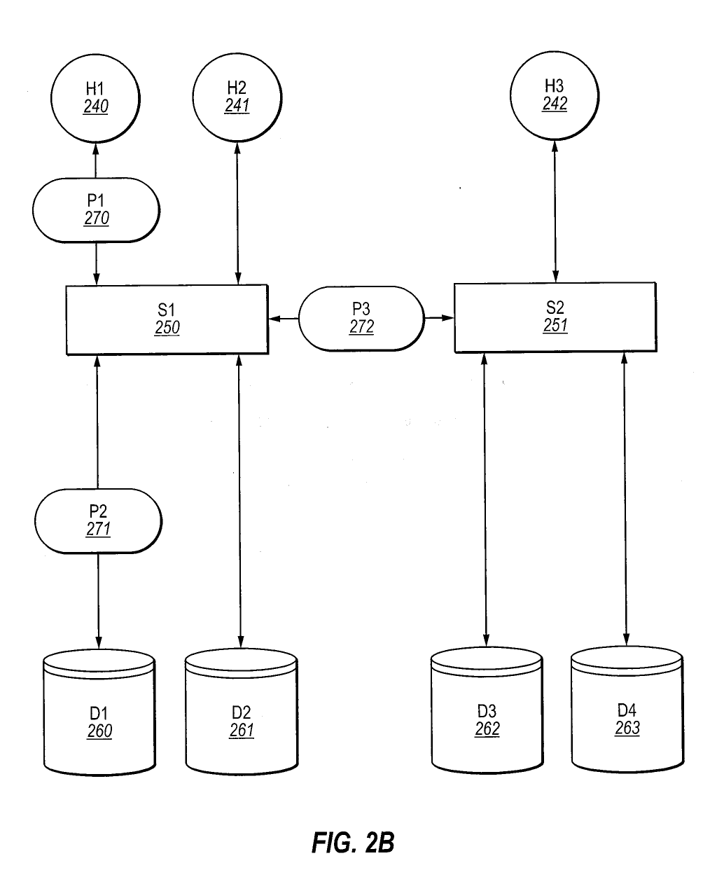

Referring to FIG. 2A, an arbitrary example of a network 200 (e.g. a SAN) including various devices, such as servers 205, switches 210, and storage devices 215 along with various interconnecting links 220 is illustrated. Some of the links 220 transfer data between the servers 205 and at least one of the switches 210. Other links 220 transfer data between the switches 210 and one of the storage devices 215. Each switch 210 can have multiple links 220 between various servers 205, storage devices 215, and other switches 210 depending on the network's 200 architecture. Each storage device 215 can have multiple links 220 for transferring data with any number of the switches 210 and/or servers 205. Any of the servers 205, switches 210, and storage devices 215 can also include links 220 for transferring data with other networks and/or other fabrics containing additional electronic devices, such as servers, switches, and storage devices.

As illustrated in FIG. 2A, at least one network tap 225 can be used to receive network data transferred in a link 220 of the network 200. The term “network data” used herein refers to data that represents data transferred in a network in some fashion or describes data transferred in a network. After receiving network data, the network tap 225 copies all frames on the link to a network probe 230 which transmogrifies the raw frames into network data that is sent to a portal 235, a computer, or other electronic device. The location of a particular probe 230 can then be determined, or estimated, by analyzing information contained in one or more headers within the network data. According to some embodiments, this network data can be compared to known data describing the network 200, such as a topology of the network 200, to determine a location of the probe 230.

Referring to FIG. 2B, an example of a FC network is illustrated. Where each link of the FC network is shown as a single line, one of ordinary skill in the art would recognize that FC networks typically have independent transmit and receive channels on each link. Probes are connected between two nodes (or fabric ports on an ISL) and simply pass data through, therefore there is typically no direction from the probe's perspective.

The FC network illustrated by FIG. 2B includes an example of a simple arbitrary fabric that includes three hosts: H1 240, H2 241, and H3 242; two switches: S1 250 and S2 251; and four drive arrays: D1 260, D2 261, D3 262, and D4 263. Each line with arrows on either end represents one FC link and each FC link has two channels, referred to hereinafter as Channel A and Channel B. A likelihood, or level of certainty, as to the location of each probe P1 270, P2 271, and P3 272 can be determined by analyzing headers of network data received by the probe.

For example, a level of certainty that the location of Probe 1 270 is likely to be connected to the link shown supporting communication between H1 240 and both D1 260 and D2 261 is determined if the following data is identified within the headers of the traffic received by Probe 1 270:

| | SID | DID |
|---|---|---|
| Channel A: | H1 | D1 |
| Channel A: | H1 | D2 |
| Channel B: | D1 | H1 |
| Channel B: | D3 | H1 |

Similarly, a level of certainty that the location of Probe 2 271 is likely to be connected to the link shown supporting communication between D1 260 and both H1 240 and H2 241 is determined if the following data is identified within the headers of the traffic received by Probe 2 271:

| | SID | DID |
|---|---|---|
| Channel A: | H1 | D1 |
| Channel A: | H2 | D1 |
| Channel B: | D1 | H2 |
| Channel B: | D1 | H1 |

A level of certainty that the location of Probe 3 272 is likely to be connected to the link shown supporting communication between S1 250 and S2 251 is determined if the following data is identified within the headers of the traffic received by Probe 3 272:

| | SID | DID |
|---|---|---|
| Channel A: | H1 | D3 |
| Channel A: | H2 | D4 |
| Channel B: | D3 | H1 |
| Channel B: | D4 | H2 |

Various other methods, in addition to the examples illustrated in reference to FIG. 2, are disclosed below for gathering information describing the location of a probe in a network.

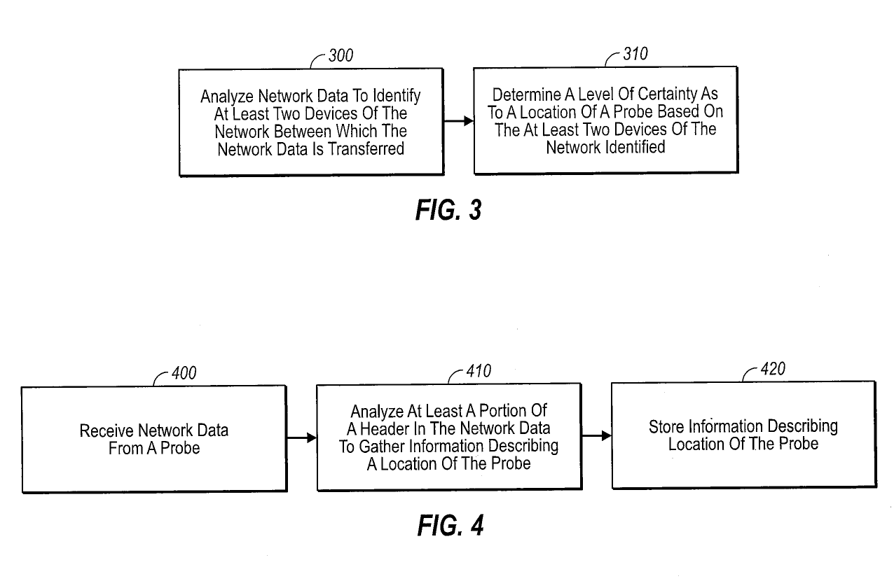

Referring to FIG. 3, a method for gathering information describing a location of a probe is illustrated. Network data is analyzed to identify at least two devices of the network between which the network data was transferred (300). For example, the devices can be a server, switch or storage device in a SAN. The network data analyzed can be a header, and the header can include one SID and one DID describing the devices between which the network data was transferred.

The network data can also be analyzed to determine if the data is a type of data sent between only two particular devices in the network. In some instance the location of the probe may be determined with exact certainty. For example, in some instances a device sends information to a switch when it first logs on to a network. This may be termed a fabric login. If the network data includes a fabric login, then the location of the probe can be determined based on a node and switch address included within a fabric login frame.

For example, in FC networks, a 3 byte (24 bits) FC address referred to as a FC Identifier (FCID) is assigned to node ports upon fabric login. This FCID can be used to uniquely identify each node in the fabric and subsequently analyzed to gather information describing the location of a probe.

Certain addresses in a network can be referred to as Well Known Addresses (WKA). In FC, for example, FCIDs in the range of 0xFFFFF0 through 0xFFFFFF are called “well known addresses.” These WKA can be associated with fabric services such as a management server (0FFFFFA), a Directory Server (0FFFFFC), and a Fabric F_Port (0FFFFFE) which is used for fabric login. WKA are defined in various FC Generic Service specifications. Any information defined in a known specification as a type of communication existing on a particular link, but not another link, can be used to identify a location of a probe according to several embodiments as described herein. The specific examples of network data unique to a particular network location discussed herein are by way of example only.

A level of certainty is assigned as to a location of the probe based on the two devices of the network identified (310). Different levels of certainty can be assigned as different information is analyzed in a frame or multiple frames are analyzed. For example, any of the types of data discussed above can be analyzed to determine a level of certainty as to the location of the probe. In some instances, an exact certainty can be determined as to the location of the probe.

Referring to FIG. 4, a method for gathering information describing a location of a probe in a network is illustrated. Network data is received from a probe (400). The network data includes, represents, or describes data, such as frames, transmitted in the network through a link coupled to the probe. The link from which the network data is received defines a location of the probe in the network. The probe can receive the network data from a tap. The tap can be directly connected to the link at the location of the probe in the network. The tap can be an optical or electrical tap depending on the type of network and the probe can be any type of probe configured to receive data from the tap. One type of probe that can be used is referred to as a “NetWisdom” probe manufactured by Finisar Corporation based in Sunnyvale, Calif.

At least a portion of the network data received from the probe is analyzed to gather information describing a location of the probe (410). For example, the network data received can include a frame. The frame can include a SID. The frame can further include a DID. The location of the probe can be determined, or a level of certainty as to the location of the probe can be determined, by analyzing the source addresses and the destination addresses in network data gathered over time.

In some instances a frame can indicate the location of the probe because it is a type of frame that is only transferred on a particular link in a network. For example, where the frame includes a fabric login the location of the probe can be determined. A fabric login reply frame can be identified by analyzing a source address to identify a WKA of a particular fabric port (F_Port, WKA 0×FFFFFE) and by analyzing a destination address to determine that the destination address is not a WKA. If this is the case, the location of the probe can be identified as between a particular N_Port and a particular switch port coupled to the particular N_Port logging into the fabric.

As described above, upon logging into a fabric, a node completes an initial communication with the fabric. Any type of initial communication can be analyzed to identify the location of the probe as being located on a link between the node and the fabric. For example, in a FC network the fabric login (FLOGI) request frame can include a source address of 0x000000.

A fabric login reply frame can also include a WWN for a device associated with the destination address in the header and a WWN for a switch that the device is coupled to. The location of the probe can be identified based on this information. The device can be a server or a storage device, for example. A storage device can include any SAN appliance including a plurality of storage disks, an enterprise storage device, or RAID hardware, for example.

A frame can also be sent to or from an N_Port and a fabric service such as the Directory Server or Management Server (N_Port-Service). The N_Port-Service frame includes a WKA FCID for a fabric service and an N_Port FCID for a device associated with a DID or a SID in the header that is not a WKA. The WWN for a switch that the N_Port is coupled to can be obtained from the WWN that is coupled to the N_Port WWN by looking up FCID to WWN mappings. For example, on fibre channel networks, this information can be obtained from services that may run on a fabric, such as the name server. The location of the probe can then be identified as between the device and the switch that are identified by the fields in the frame.

The frame can also indicate that the location of the probe is on an ISL. For example, where the information includes an SID and a DID, and the SID and the DID are both domain controller addresses, the location of the probe can be identified as an ISL between the two switches with Domain IDs that match the third byte in the domain controller addresses.

The analysis can also determine a level of certainty as to the location of the probe from the network data analyzed. For example, a level of certainty can be increased where analysis can eliminate at least one location as a possible location of the probe. In some instances a topology of the network can be analyzed in conjunction with the network data to remove locations in the network from consideration as the location of the probe, thereby increasing a level of certainty that one or more of the other locations in the network are the location of the probe. Information gathered describing the location of the probe can be stored in memory (420).

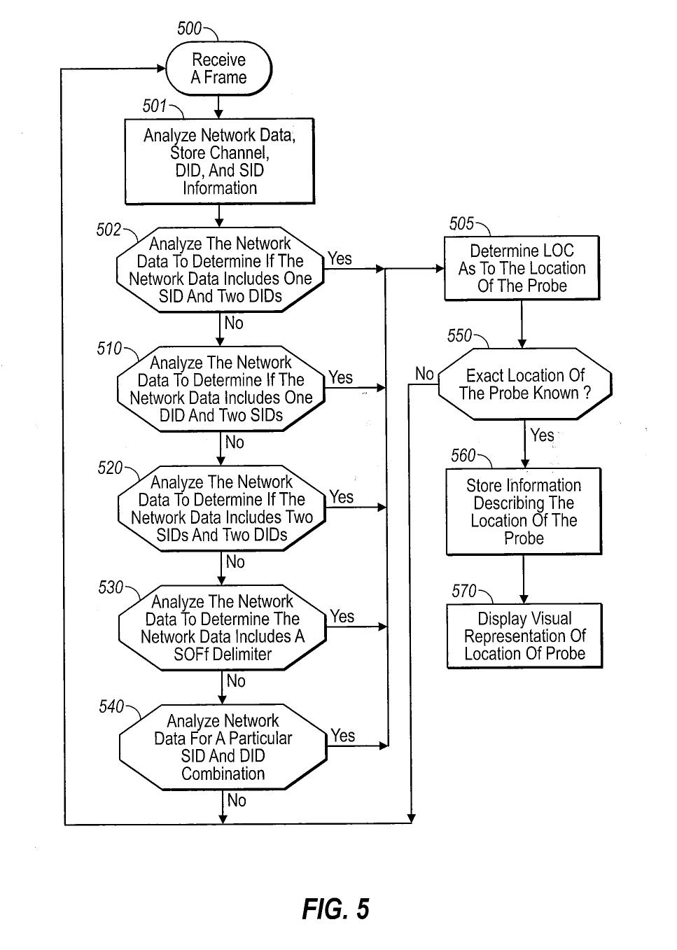

Referring to FIG. 5, a method for gathering information describing a location of a probe in a SAN is illustrated. The method may provide an exact certainty as to the location of the probe in the SAN, or the method may provide a lower level of certainty as to the location of the probe in the SAN. Network data is received (500). The network data can be received by a probe from a tap. The network data can be derived from frames and can also be received by a portal from a probe. The network data can also be received by any data processing device from any source including, for example, a tap, probe, portal, computer readable medium, wireless connections, the Internet, a network, etc.

The network data is analyzed to obtain a SID and DID (501). This network data and all previous traffic (i.e., stored DID/SID pairs on both channels) can be analyzed to determine if the network data includes one unique SID and two unique DIDs (502). For example, the network data can be analyzed to determine whether the traffic on channel A (i.e., transmit or receive) has an identical N_Port SID and all channel B (i.e., receive or transmit) traffic has the same DID and the traffic on channel A has two or more unique N_Port DIDs or the traffic on channel B includes two or more unique N_Port SIDs. Based on this analysis a level of certainty can be made as to the location of the probe (505). For example, links that cannot transfer network data between the N_Ports can be eliminated from consideration as a location of the probe. In this instance a level of certainty that the location of the probe is closer to the N_Port represented by the identical FCIDs is increased.

The network data can be analyzed to determine if the traffic includes one DID and two unique SIDs (510). For example, traffic can be analyzed to determine whether the traffic on channel A (i.e., transmit or receive) has identical N_Port DIDs and channel B (i.e., receive or transmit) traffic has the same N_Port SIDs and the traffic on channel A has two or more unique N_Port SIDs or the traffic on channel B includes two or more unique N_Port DIDs. Based on this analysis, a level of certainty can be made as to the location of the probe (505). For example, links that cannot transfer network data between the DID and both SIDs can be eliminated from consideration as a location of the probe. In this instance a level of certainty that the location of the probe is closer to the N_Port represented by the identical FCIDs is increased.

Network data can be analyzed to determine if the traffic includes at least two unique SIDs and two unique DIDs (520) on either channel. Non-compliant locations can be removed from consideration. In this instance, a level of certainty that the location of the probe is on an ISL is determined (505) and typically increased. If the network only includes a single ISL, for example, then the exact location of the probe can be determined as the location of the only ISL of the network.

Network data can be analyzed to determine whether the frame includes a Start of Frame Fabric (SOFf) delimiter (530). If the frame includes a SOFf delimiter then a certainty that the location of the probe is on an ISL is determined (505). For example, according to the FC protocol, a SOFf delimiter includes the ordered set K28.5 D21.5 D24.2 D24.2.

The network data can also be analyzed to detect a particular SID and DID combination (540). For example, even where all traffic is between a particular pair of N_Ports, it can be determined that the location of the probe is on a link that transfers data between the two N_Ports. Therefore, any links that cannot transfer data between the two N Ports can be eliminated from consideration as the location of the probe. As a result, a level of certainty as to the location of the probe can be determined (505).

Any amount of network data including number of frames can be analyzed over any time period. Any combination of the criteria for determining the location of the probe can also be used. For example, a frame may be analyzed to provide a first level of certainty as to the location of the probe. A second frame received by the probe may also be analyzed and a result of the analysis may increase the level of certainty as to the location of the probe. Over time, as links in a network are discounted as possible locations for the probe or other links are identified as more likely locations of the probe, the location of the probe can be identified with increased certainty until, in some instances, an exact location of the probe is determined.

If an exact location of a probe or locations of multiple probes at the same or different locations is known, (550) information describing the location of the probe(s) can be stored (560). The location, or locations if there are multiple taps at different locations, can be included in a topology of the network. The topology can be displayed to a user including a visual representation of the location of the probe (570), or locations of the various probes. The probes can deliver accurate, real-time statistics to a portal or other analysis device and the location of the probes can be used to help identify the locations of problems in the network without the need for a user to have prior knowledge of the location at which the probe is inserted. When the exact location of the probe is not known, (550) additional network data, such as frames, traffic, or information describing frames and traffic transferred in the link attached to the top, can be received (500), and continued analysis can be conducted to increase the certainty as to the location of the probe until an exact location of the probe can be determined. Any combination of analysis criteria illustrated in FIGS. 3-5 can be conducted in any order using any number of frames over any period of time.

A device for performing the analysis described above can include a special purpose, general purpose, hand-held, desktop, portable, or other data processing device. For example, the network data processing device can include a data processing device that includes a conventional computer. Additional processors and hardware can also be implemented for performing the above described functions. Thus, any of the embodiments may comprise any number of special purpose and/or general-purpose computers including various computer hardware, as discussed in greater detail below.

Embodiments within the scope of those illustrated herein can also include computer-readable media for carrying or having computer-executable instructions or data structures stored thereon. Such computer-readable media can be any available media that can be accessed by a general purpose, special purpose computer, or other data processing device. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

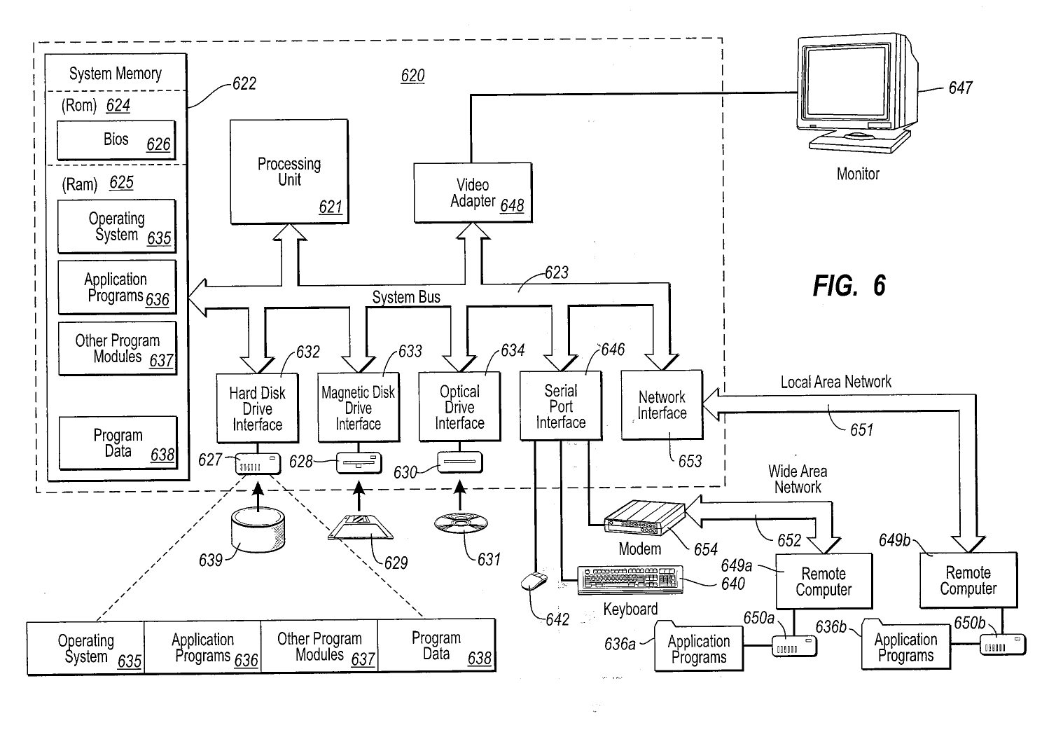

FIG. 6 and the following discussion are intended to provide a brief, general description of an example of a suitable computing environment in which several embodiments may be implemented. Although not required, several embodiments will be described in the general context of computer-executable instructions, such as program modules, being executed by computers in network environments. Generally, program modules include routines, programs, objects, components, data structures, etc., that perform particular tasks such as those described above or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the embodiments illustrated herein may be practiced in network computing environments with many types of computer system configurations, including personal computers, hand-held devices, multi-processor systems, microprocessor-based or programmable consumer electronics, network PCs, minicomputers, mainframe computers, and the like. Several embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 6, an example of a system for implementing several embodiments includes a general purpose computing device in the form of a conventional computer 620, including a processing unit 621, a system memory 622, and a system bus 623 that couples various system components including the system memory 622 to the processing unit 621. The system bus 623 may be any of several types of bus structures including a memory bus or memory controller, a peripheral bus, and a local bus using any of a variety of bus architectures. The system memory includes read only memory (ROM) 624 and random access memory (RAM) 625. A basic input/output system (BIOS) 626, containing the basic routines that help transfer information between elements within the computer 620, such as during start-up, may be stored in ROM 624.

The computer 620 may also include a magnetic hard disk drive 627 for reading from and writing to a magnetic hard disk 639, a magnetic disk drive 628 for reading from or writing to a removable magnetic disk 629, and an optical disk drive 630 for reading from or writing to removable optical disk 631 such as a CD-ROM or other optical media. The magnetic hard disk drive 627, magnetic disk drive 628, and optical disk drive 630 are connected to the system bus 623 by a hard disk drive interface 632, a magnetic disk drive-interface 633, and an optical drive interface 634, respectively. The drives and their associated computer-readable media provide nonvolatile storage of computer-executable instructions, data structures, program modules and other data for the computer 620. Although the exemplary environment described herein employs a magnetic hard disk 639, a removable magnetic disk 629 and a removable optical disk 631, other types of computer readable media for storing data can be used, including magnetic cassettes, flash memory cards, digital versatile disks, Bernoulli cartridges, RAMs, ROMs, and the like.

Program code comprising one or more program modules may be stored on the hard disk 639, magnetic disk 629, optical disk 631, ROM 624 or RAM 625, including an operating system 635, one or more application programs 636, other program modules 637, and program data 638. A user may enter commands and information into the computer 620 through keyboard 640, pointing device 642, or other input devices (not shown), such as a microphone, joy stick, game pad, satellite dish, scanner, or the like. These and other input devices are often connected to the processing unit 621 through a serial port interface 646 coupled to system bus 623. Alternatively, the input devices may be connected by other interfaces, such as a parallel port, a game port or a universal serial bus (USB). A monitor 647 or another display device is also connected to system bus 623 via an interface, such as video adapter 648. In addition to the monitor, personal computers typically include other peripheral output devices (not shown), such as speakers and printers.

The computer 620 may operate in a networked environment using logical connections to one or more remote computers, such as remote computers 649a and 649b. Remote computers 649a and 649b may each be another personal computer, a server, a router, a network PC, a peer device or other common network node, and typically include many or all of the elements described above relative to the computer 620, although only memory storage devices 650a and 650b and their associated application programs 636a and 636b have been illustrated in FIG. 6. The logical connections depicted in FIG. 6 include a local area network (LAN) 651 and a wide area network (WAN) 652 that are presented here by way of example and not limitation. Such networking environments are commonplace in office-wide or enterprise-wide computer networks, intranets and the Internet.

When used in a LAN networking environment, the computer 620 is connected to the local network 651 through a network interface or adapter 653. When used in a WAN networking environment, the computer 620 may include a modem 654, a wireless link, or other means for establishing communications over the wide area network 652, such as the Internet. The modem 654, which may be internal or external, is connected to the system bus 623 via the serial port interface 646. In a networked environment, program modules depicted relative to the computer 620, or portions thereof, may be stored in the remote memory storage device. It will be appreciated that the network connections shown are exemplary and other means of establishing communications over wide area network 652 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for gathering information describing a location of a probe in a network, the method comprising:
passively monitoring network data at a probe, the probe being passively connected to the network via a tap;
analyzing network data received by the probe to identify at least two devices in the network between which the network data is transferred; and
storing information describing the location of the probe based on the at least two devices of the network identified.

2. A method according to claim 1, wherein the network data is analyzed to locate information describing a source from which the network data was sent and information describing a destination to which the network data was sent.

3. A method according to claim 1, wherein the network data includes a fabric login, a directory service, or two domain controller addresses, the method further comprising identifying the location of the probe based on two addresses within the fabric login, directory service, or two domain controller addresses.

4. A method according to claim 1, wherein locations within the network are excluded from consideration as the location of the probe based on information in the network data describing a source and intended destination of the network data.

5. A method for gathering information describing a location of a probe in a storage area network (SAN), the method comprising:
receiving network data from a probe, the network data representing data transmitted in the SAN through a link coupled to the probe, the link in the SAN from which the information is received defining a location of the probe; and
analyzing at least a portion of a header within the network data to gather information describing the location of the probe.

6. A method according to claim 5, wherein a source address in the header is analyzed to determine the location of the probe.

7. A method according to claim 5, wherein a destination address in the header is analyzed to determine the location of the probe.

8. A method according to claim 5, wherein the information gathered includes a fabric login.

9. A method according to claim 8, wherein the fabric login is identified by analyzing a source address to identify a well-known address (WKA) of a particular fabric port and by analyzing a destination address to determine that the destination address is not a WKA, the method further comprising identifying the location of the probe as between the particular fabric port and a switch coupled to the particular fabric port.

10. A method according to claim 8, wherein the fabric login includes a source address of 0x000000.

11. A method according to claim 8, wherein the fabric login includes a World Wide Name (WWN) for a device associated with an address in the header and the fabric login further includes a WWN for a switch that the device is coupled to, the method further comprising identifying the location of the probe as between the device and the switch.

12. The method according to claim 11, wherein the device is a server or a storage device.

13. The method according to claim 11, wherein the address is a destination address or a source address.

14. A method according to claim 5, wherein the link is coupled to the probe via a tap.

15. A method according to claim 5, wherein the information gathered includes a node port service (N_Port-Service).

16. A method according to claim 15, wherein the N_Port-Service includes a World Wide Name (WWN) for a device associated with a destination address or a source address in the header that is not a well-known address (WKA) and the N_Port-Service includes a WWN for a switch that the device is coupled to, the method further comprising identifying the location of the probe as between the device and the switch.

17. A method according to claim 5, wherein the information describing the location of the probe indicates that the probe is on an Inter-Switch Link (ISL).

18. A method according claim 5, wherein the information includes a source address and a destination address, wherein if the source address and the destination address are both Domain controller addresses the location of the probe is identified as an Inter-Switch Link (ISL) between two switches.

19. A method according to claim 5, wherein if the header includes one source address and two destination addresses, the method further comprises identifying a level of certainty that a link that transfers network data between the source address and both of the two destination addresses is the location of the probe.

20. A method according to claim 5, wherein if the header includes two source addresses and one destination address, the method further comprises identifying with a level of certainty that a link that is capable of transferring network data between the two source addresses and the one destination addresses is the location of the probe.

21. A method according to claim 5, wherein if the header includes two source addresses and two destination addresses, the method further comprises identifying the location of the probe as an Inter-Switch Link (ISL).

22. A method according to claim 5, wherein if the header includes a Start of Frame Fabric (SOFf) delimiter, the method further comprises identifying the location of the probe to a level of certainty as an Inter-Switch Link (ISL).

23. A method according to claim 2, wherein the SOFf delimiter includes the ordered set K28.5 D21.5 D24.2 D24.2.

24. A method according to claim 5, wherein if the network data includes multiple headers with a source address and a destination address, assigning a level of certainty that the location of the probe is between the source address and the destination address.

25. A method according to claim 5, further comprising:
comparing the information to a topology of the SAN to determine a level of certainty as to the location of the probe in the SAN.

26. A method according to claim 5, further comprising:
generating a topology of the SAN, the topology including a visual representation of a location of the probe in the SAN.

27. A method according to claim 26, further comprising:
displaying the topology.

28. A computer readable medium having computer executable instructions stored on the computer readable medium for performing the method of claim 5.

29. A data processing device comprising the computer readable medium of claim 28, the data processing device including a data processor for executing the computer executable instructions.

30. A method for gathering information describing a location of a probe in a network, the method comprising:
first searching network data received from the probe for at least one of the following:
a fabric login;
a node port to service transmission; or
a transmission between two switches;
if the fabric login, node port to service transmission, or transmission between two switches is found, the method further comprises:
identifying the location of the probe based on the fabric login, node port to service transmission, or transmission between two switches.

31. A method according to claim 30, further comprising:
if the fabric login, node port to service transmission, or transmission between two switches is not found, the method further comprises:
searching the network data received from the probe for at least one of the following:
headers on a first channel coupled to the probe that include identical source address identifiers (SIDs) and headers on a second channel coupled to the probe that include identical destination address identifiers (DIDs) that are the same as the SIDs on the first channel and at least two unique DIDs are found on the first channel or at least two unique SIDs are found on the second channel;
headers on the first channel that include identical DIDs and headers on the second channel that include identical SIDs that are the same as the DIDs on the first channel and at least two unique SIDs are found on the first channel or at least two unique DIDs are found on the second channel;
headers that include at least two unique source addresses and at least two unique destination addresses on the first and second channels;
a start of frame field that is a start of frame fabric delimiter; and
headers including exactly two unique SIDs or DIDs in all of the source and destination addresses of the network data.

32. A method according to claim 31, further comprising:
assigning a level of certainty to at least one location in the network that the at least one location is the location of the probe if the network data includes the headers on a first channel coupled to the probe that include identical source address identifiers (SIDs) and headers on a second channel coupled to the probe that include identical destination address identifiers (DIDs) that are the same as the SIDs on the first channel and at least two unique DIDs are found on the first channel or at least two unique SIDs are found on the second channel; the headers on the first channel that include identical DIDs and headers on the second channel that include identical SIDs that are the same as the DIDs on the first channel and at least two unique SIDs are found on the first channel or at least two unique DIDs are found on the second channel; headers that include at least two unique source addresses and at least two unique destination addresses on the first and second channels; the start of frame field that is a start of frame fabric delimiter; or the headers including exactly two unique SIDs or DIDs in all of the source and destination addresses of the network data.
